(19) United States
(12) Patent Application Publication
(10) Pub. No.: US 2026/0361971 A1
(43) Pub. Date: Nov. 12, 2026

(54) Systems and Methods for Generating Unified Video Advertisements from Audio Advertisements

(71) Applicant: Consumable Inc., Jackson, WY (US)

(72) Inventors: Mark Levin, Potomac, MD (US); Travis Beale, Cabot, PA (US)

(21) Appl. No.: 19/746,254

(22) Filed: Jul. 17, 2026

Related U.S. Application Data
(63) Continuation-in-part of application No. 17/938,902, filed on Sep. 6, 2022, now abandoned.

(51) Int. Cl. H04N 21/81; H04N 21/233; H04N 21/234; H04N 21/24

(52) U.S. Cl. CPC H04N 21/812; H04N 21/233; H04N 21/234; H04N 21/2408

(57) ABSTRACT

In one embodiment, a method includes receiving, from a first server, an audio advertisement response; extracting a network address for an audio media file and companion banner metadata; identifying companion trackers from the metadata; retrieving the audio media file; determining its duration; converting the companion trackers into video interaction trackers; generating a video slate with a duration matching the audio media file and including a visual media file; encoding the video slate and audio media file into a single video advertisement media file that is associated with the video interaction trackers; transmitting the encoded video advertisement media file to client devices for display; detecting playback or interaction tracking events through the video interaction trackers; and transmitting to each requesting system a video advertisement response referencing the encoded video advertisement media file and the tracking events.

### PRIORITY

This application is a continuation-in-part under 35 U.S.C. § 120 of U.S. patent application Ser. No. 17/938,902, filed 6 Sep. 2022, which is incorporated herein by reference.

### TECHNICAL FIELD

This disclosure generally relates to digital advertising systems, and in particular relates to systems and methods for generating unified video advertisements from audio advertisements.

### BACKGROUND

Programmatic advertising systems commonly deliver advertisements in accordance with standardized protocols, including the Interactive Advertising Bureau (IAB) Video Ad Serving Template (VAST) specification and related frameworks. In audio-centric advertising environments, an advertisement response typically includes a combination of assets and associated data, such as an audio media file, a companion banner advertisement, one or more click-through URLs, tracking pixel URLs, and additional metadata describing the advertisement creative. Conventionally, these elements are rendered through separate advertisement placements, namely an audio playback component and a companion banner display component. These components are generally executed in distinct execution environments, which may involve separate HTML containers, independent JavaScript execution contexts, discrete media playback engines, multiple network resource requests, and individualized advertisement tracking logic. Such separation can introduce inefficiencies in resource utilization, increase implementation complexity, and complicate synchronization and measurement of user engagement across the different advertisement elements.

### SUMMARY OF PARTICULAR EMBODIMENTS

In particular embodiments, a system disclosed herein can extract companion banner metadata from audio advertisement responses, retrieve and incorporate companion banner assets into a video slate, and convert and combine the slate with an associated audio media file. The system can further translate banner interaction tracking mechanisms into video interaction tracking events. Because companion banner tracking events are typically implemented separately from audio or video tracking events, converting the audio advertisement and companion banner advertisement into a unified video advertisement may include converting banner tracking pixels into corresponding video event trackers. The system can then encode the resulting advertisement as a video media file compatible with video advertising environments. The generated video advertisement may be delivered to a variety of digital media environments including mobile applications, web-based video players, connected television (CTV) platforms, and digital out-of-home (DOOH) display systems.

In particular embodiments, the techniques described herein relate to a method including, by one or more computing systems: electronically receiving, from a first server, an audio advertisement response; extracting, from the audio advertisement response, companion banner metadata and a network address directed to an audio media file; identifying, based on the companion banner metadata, one or more companion trackers associated with the audio advertisement response; retrieving, via the network address, the audio media file; determining a duration of the audio media file; transforming the one or more companion banner trackers into one or more video interaction trackers; generating a video slate having a slate duration corresponding to the duration of the audio media file, wherein the video slate includes a visual media file; encoding the video slate and the audio media file into a single encoded video advertisement media file, wherein the single encoded video advertisement is associated with the one or more video interaction trackers; electronically transmitting, to a plurality of client devices, the single encoded video advertisement media file for display; detecting, via the one or more video interaction trackers, one or more tracking events associated with playbacks or interactions of the single encoded video advertisement media file; and electronically transmitting, to each of one or more requesting systems that request video advertisement responses, a video advertisement response referencing the single encoded video advertisement media file and the one or more tracking events.

In particular embodiments, the techniques described herein relate to a method, further including: storing the single encoded video advertisement media file, the audio media file, and one or more of the companion banner metadata in a plurality of network-based non-transitory storage devices having a collection of video advertisement media files and audio media files stored thereon; providing, to a plurality of users over a network, remote access to the single encoded video advertisement media file, the audio media file, and the stored companion banner metadata; detecting an update to the audio media file or one or more of the stored companion banner metadata by one of the users; converting the update to an updated encoded video advertisement media file; storing the updated encoded video advertisement media file in the collection of video advertisement media files and audio media files; and automatically transmitting the updated encoded video advertisement media file to all of the users over the network in real time.

In particular embodiments, the techniques described herein relate to a method, further including: storing the audio media file in a network-based non-transitory storage device; detecting an update to the audio media file; generating an updated video slate based on the update audio media file; encoding the updated video slate and the updated audio media file into an updated single encoded video advertisement media file; and electronically transmitting, to the first server, an updated video advertisement response referencing the updated single encoded video advertisement media file.

In particular embodiments, the techniques described herein relate to a method, wherein retrieving the audio media file includes: following one or more wrapper redirects in the audio advertisement response until an inline advertisement identifying the audio media file is reached; selecting the audio media file from one or more audio media files identified by the inline advertisement; and retrieving the selected audio media file using a network request.

In particular embodiments, the techniques described herein relate to a method, wherein the one or more companion trackers include one or more of a banner impression tracker, an audio impression tracker, or a banner click tracker.

In particular embodiments, the techniques described herein relate to a method, wherein the one or more video interaction trackers include one or more of a video impression tracker, a video click tracker, or a QR code attribution model.

In particular embodiments, the techniques described herein relate to a method, wherein generating the video slate includes incorporating a QR code generated from a click-through URL, a landing page URL, or an advertiser domain associated with the audio advertisement response.

In particular embodiments, the techniques described herein relate to a method, wherein detecting the tracking events includes correlating a scan of the QR code with a delivered impression of the single encoded video advertisement media file.

In particular embodiments, the techniques described herein relate to a method, wherein correlating the scan of the QR code with the delivered impression includes matching at least one network-location signal associated with the scan to at least one network-location signal associated with the delivered impression within a predetermined time window.

In particular embodiments, the techniques described herein relate to a method, wherein the one or more companion trackers include a banner impression tracker or an audio impression tracker, wherein the one or more video interaction trackers include a video impression tracker, and wherein detecting the tracking events includes: mapping the banner impression tracker or audio impression tracker to a video impression event tracked by the video impression tracker.

In particular embodiments, the techniques described herein relate to a method, wherein the one or more companion trackers include a banner click tracker, wherein the one or more video interaction trackers include a video click tracker or a QR code attribution model, and wherein detecting the tracking events includes: mapping the banner click tracker to at least one of a video overlay click event tracked by the video click tracker or a QR code scan event tracked by the QR code attribution model.

In particular embodiments, the techniques described herein relate to a method, further including: generating a plurality of candidate encoded video advertisement media files from the audio media file; delivering the plurality of candidate encoded video advertisement media files across the plurality of client devices; detecting tracking events associated with playbacks or interactions of the plurality of candidate encoded video advertisement media files; determining performances of the plurality of candidate encoded video advertisement media files based on the tracking events; and performing one or more actions on the plurality of candidate encoded video advertisement media files based on the performances.

In particular embodiments, the techniques described herein relate to a method, wherein the one or more actions include selecting, ranking, prioritizing, suppressing, or regenerating one or more candidate encoded video advertisement media files of the plurality of candidate encoded video advertisement media files.

In particular embodiments, the techniques described herein relate to a method, further including: selecting, based on the performances, one or more visual elements from one or more candidate encoded video advertisement media files of the plurality of candidate encoded video advertisement media files, wherein the one or more candidate encoded video advertisement media files are associated with one or more of a particular advertiser, a particular content category, a particular campaign, or a particular entity attribute; and integrating the selected visual elements into a subsequently generated encoded video advertisement associated with one or more of the particular advertiser, the particular content category, the particular campaign, or the particular entity attribute.

In particular embodiments, the techniques described herein relate to a method, further including: deriving one or more visual elements from the companion banner metadata, wherein the video slate further includes the one or more visual elements.

In particular embodiments, the techniques described herein relate to one or more computer-readable non-transitory storage media embodying software that is operable when executed to perform operations including: electronically receiving, from a first server, an audio advertisement response; extracting, from the audio advertisement response, companion banner metadata and a network address directed to an audio media file; identifying, based on the companion banner metadata, one or more companion trackers associated with the audio advertisement response; retrieving, via the network address, the audio media file; determining a duration of the audio media file; transforming the one or more companion banner trackers into one or more video interaction trackers; generating a video slate having a slate duration corresponding to the duration of the audio media file, wherein the video slate includes a visual media file; encoding the video slate and the audio media file into a single encoded video advertisement media file, wherein the single encoded video advertisement is associated with the one or more video interaction trackers; electronically transmitting, to a plurality of client devices, the single encoded video advertisement media file for display; detecting, via the one or more video interaction trackers, one or more tracking events associated with playbacks or interactions of the single encoded video advertisement media file; and electronically transmitting, to each of one or more requesting systems that request video advertisement responses, a video advertisement response referencing the single encoded video advertisement media file and the one or more tracking events.

In particular embodiments, the techniques described herein relate to a system including: one or more processors; and a non-transitory memory coupled to the processors including instructions executable by the processors, the processors operable when executing the instructions to perform operations including: electronically receiving, from a first server, an audio advertisement response; extracting, from the audio advertisement response, companion banner metadata and a network address directed to an audio media file; identifying, based on the companion banner metadata, one or more companion trackers associated with the audio advertisement response; retrieving, via the network address, the audio media file; determining a duration of the audio media file; transforming the one or more companion banner trackers into one or more video interaction trackers; generating a video slate having a slate duration corresponding to the duration of the audio media file, wherein the video slate includes a visual media file; encoding the video slate and the audio media file into a single encoded video advertisement media file, wherein the single encoded video advertisement is associated with the one or more video interaction trackers; electronically transmitting, to a plurality of client devices, the single encoded video advertisement media file for display; detecting, via the one or more video interaction trackers, one or more tracking events associated with playbacks or interactions of the single encoded video advertisement media file; and electronically transmitting, to each of one or more requesting systems that request video advertisement responses, a video advertisement response referencing the single encoded video advertisement media file and the one or more tracking events.

Technical advantages of certain embodiments of this disclosure may include one or more of the following. Certain embodiments can improve the efficiency of advertisement delivery and rendering through consolidation of multiple advertisement rendering components into a single encoded media asset. Conventional audio advertisement implementations typically require the concurrent operation of multiple resource-intensive processes, including audio playback rendering, banner image retrieval, execution of banner rendering logic, issuance of tracking pixel requests, and execution of JavaScript associated with advertisement frameworks. The combined operation of these processes increases the computational burden placed on client devices and introduces additional runtime complexity. By contrast, the disclosed systems and methods generate a unified video advertisement in which the audio media and companion banner visual elements are combined into a single encoded media file. This unified architecture reduces the number of discrete runtime components needed for advertisement playback, thereby streamlining the rendering pipeline. As a result, the disclosed systems and methods can achieve measurable improvements in system performance, including reductions in CPU utilization during advertisement playback, decreases in memory consumption associated with rendering operations, and lower network bandwidth consumption due to reduced numbers of resource requests. Additionally, the consolidation of advertisement assets into a single media file can reduce advertisement load latency by minimizing the need for parallel resource fetching and execution. Furthermore, by encapsulating advertisement functionality within a single encoded video asset, certain embodiments can reduce reliance on external scripting and auxiliary resources, thereby mitigating the likelihood that the advertisement will be identified as a resource-intensive or “heavy” advertisement by browser or platform-level resource monitoring systems. This, in turn, can improve the reliability and consistency of advertisement delivery across diverse execution environments.

Other technical advantages will be readily apparent to one skilled in the art from the following figures, descriptions, and claims. Moreover, while specific advantages have been enumerated above, various embodiments may include all, some, or none of the enumerated advantages.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example audio advertisement transformation pipeline.

FIG. 2 illustrates an example video slate composition.

FIG. 3 illustrates an example event-driven tracking framework for advertisement interactions across multiple media types.

FIG. 4 illustrates an example method for generating unified video advertisements from audio advertisements.

FIG. 5 illustrates an example computer system.

### DESCRIPTION OF EXAMPLE EMBODIMENTS

Conventional advertising systems may suffer from several technical disadvantages. Rendering advertisements using separate advertisement placements may result in increased client-side processing overhead and require multiple network requests to fetch banner assets, tracking pixels, and associated scripts. Conventional advertising systems may may further require additional JavaScript execution to render and manage the banner advertisement and introduce synchronization complexity between the audio playback component and the companion banner display. The use of multiple asynchronous resource loads can increase latency in advertisement rendering and contribute to a higher computational load on client devices, including mobile devices, connected television devices, and embedded media players. Additionally, the combined resource consumption associated with audio playback components, banner rendering scripts, tracking pixels, and related resources can result in the creation of “heavy advertisements,” in which CPU utilization, memory consumption, or network bandwidth usage exceeds browser or device resource thresholds. Conventional advertising systems may also increase the complexity of attribution of advertising events, including impressions, clicks, and QR code scans.

In some client environments, such heavy advertisements may trigger browser- or platform-level mitigation mechanisms that automatically throttle or disable advertisement execution when resource usage surpasses predetermined thresholds. Such mitigation can degrade advertisement performance, interrupt advertisement playback, or prevent user interaction with the advertisement. These technical issues are particularly pronounced in constrained device environments, including connected television devices, mobile applications, browser-based video players, and digital out-of-home (DOOH) media players. Accordingly, conventional advertising systems that rely on separate audio and banner rendering components can lead to inefficient resource utilization and increased computational overhead in client devices. The systems and methods disclosed herein address these issues by consolidating audio and companion banner advertisement components into a single encoded video advertisement unit, thereby reducing client-side rendering complexity and mitigating heavy advertisement resource consumption.

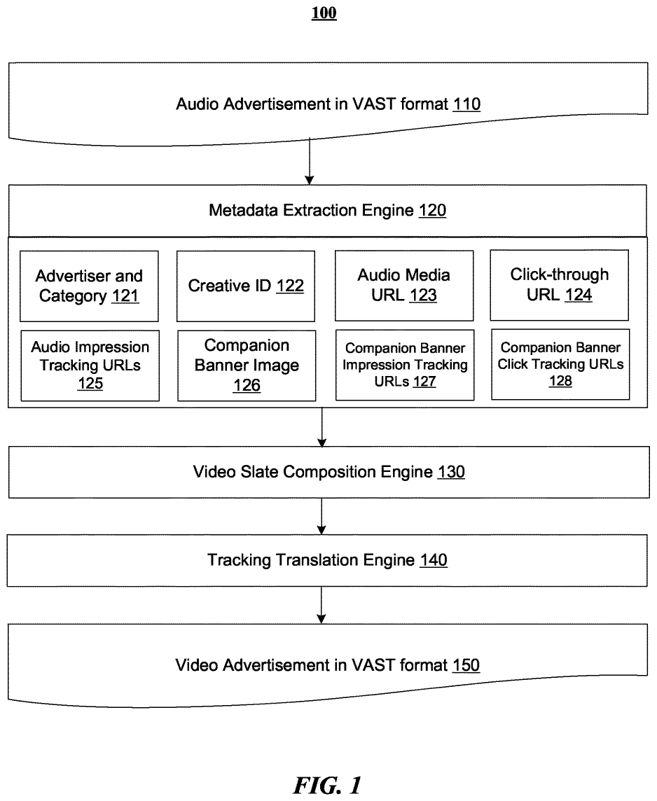

FIG. 1 illustrates an example audio advertisement transformation pipeline 100. In particular embodiments, the system may receive an audio advertisement response in VAST format 110. The audio advertisement response may comprise an audio media file and companion banner metadata. In particular embodiments, an audio advertisement may be delivered in VAST format as an XML document that identifies one or more audio media files, tracking pixels, companion banner assets, and associated metadata. In conventional audio advertisement placements, such as podcast placements, the companion banner is often not rendered or otherwise utilized. Although rendering of the companion banner may be optional in many implementations, advertisement placements that support rendering of the companion banner can be desirable to audio advertisers because such placements provide an additional visual presentation associated with the audio advertisement.

A metadata extraction engine 120 may extract companion banner assets and associated tracking metadata from the audio advertisement response. The following illustrates example companion banner metadata from a VAST markup excerpt.

```
<Creative sequence=”1” id=”1”>
  <CompanionAds>
    <Companion id=”1” width=”300” height=”250”>
      <StaticResource
      creativeType=”image/jpeg”>https://cdn.example.com/creative_image.jpg</Static
      Resource>
      <CompanionClickThrough>
        <![CDATA[https://www.example.com/landingpage]]>
      </CompanionClickThrough>
      <CompanionClickTracking>https://adserver.example.com/slicktracker1</Compa
      nionClickTracking>
      <CompanionClickTracking>https://adserver.example.com/clicktracker2</Compa
      nionClickTracking>
      <TrackingEvents>
        <Tracking
        event=”creativeView”>https://adserver.example.com/impressiontracker1<
        /Tracking>
        <Tracking
        event=”creativeView”>https://adserver.example.com/impressiontracker2<
        /Tracking>
      </TrackingEvents>
    </Companion>
  </CompanionAds>
  <UniversalAdId>creativeid123</UniversalAdId>
</Creative>
```

As can be seen in the example companion banner metadata above, multiple trackers are associated with each type of VAST advertisement tracking event. For a given tracking event, respective platforms within an advertisement supply chain may attach their own trackers. In addition, one or more measurement pixels, identity synchronization pixels, and data collection pixels can be included by an advertiser or by other parties within the advertisement supply chain, resulting in a plurality of trackers being associated with the same tracking event.

In particular embodiments, the metadata may include advertiser and category 121, creative ID 122, audio media URL 123, click-through URL 124, audio impression tracking URLs 125, companion banner image 126, companion impression tracking URLs 127, and companion banner click tracking URLs 128.

The creative ID 122 (denoted by crid) may comprise a string of characters representing an identifier that is unique to the delivered advertisement creative within a responding advertiser's platform. The crid may be provided directly with the audio advertisement metadata, inferred from other metadata present in the advertisement, or provided together with the advertisement by a programmatic advertisement exchange. In particular embodiments, the crid may identify the advertisement creative independently of delivery-specific feedback or tracking events, while tracking pixels associated with individual advertisement deliveries may remain unique to those deliveries.

The global creative ID (denoted by gcrid) may comprise a string of characters representing an identifier that is globally unique to the delivered advertisement creative. The gcrid may be synthesized by combining the crid with an advertising platform identifier.

The system may identify entity attributes associated with an advertiser, advertisement creative, advertised product, or audio media file. As used herein, entity attributes may include metadata obtained from an audio advertisement response, metadata retrieved from one or more network-accessible resources, or metadata inferred after delivery of the audio advertisement response. In particular embodiments, the entity attributes may include a click-through URL 124 (denoted by url1). The click-through URL 124 may represent an initial URL to which a user is redirected in response to clicking on the companion banner advertisement. The click-through URL 124 may comprise an overall click-through URL for the advertisement or a click-through URL specific to the companion banner advertisement.

In particular embodiments, the entity attributes may include a landing page URL (denoted by url2). The landing page URL may represent a final URL of a web page to which the user is redirected after clicking on the companion banner advertisement and after traversing one or more redirect actions.

In particular embodiments, the entity attributes may include an advertiser domain (denoted by url3). The advertiser domain, also referred to as an ad domain, may comprise a domain representing the advertiser that purchased the advertisement impression. Exemplary ad domains may include the home page of the entity, brand, or product. The ad domain may be provided directly with the audio advertisement metadata, inferred from other metadata present in the advertisement, or provided together with the advertisement by a programmatic advertisement exchange.

As another entity attribute, the content category 121 may represent a category of the advertiser according to the IAB1 taxonomy or another standard content taxonomy. The content category may be provided directly within the audio advertisement, provided together with the advertisement by a programmatic advertisement exchange, or inferred from the advertiser domain (url3).

The advertisement image URL (denoted by url4), also referred to as a companion advertisement URL, may comprise an optional URL that points to a static image having a standard size suitable for Internet advertising and formatted as a PNG, GIF, JPEG, or other standard digital image format.

The audio media URL 123 (denoted by url5) may comprise a URL that points to an audio file in MP3, WAV, OGG, or another standard digital audio format and that may be retrieved using a standard HTTP GET request. The audio media file may include audio media file attributes, which include information that is directly related to the audio file itself. An example of audio file attributes includes an advertisement duration, which may represent a duration of the audio content in the advertisement, expressed in seconds. The duration may be provided directly within the audio advertisement, inferred from the audio media URL (url5), or provided together with the advertisement by a programmatic advertisement exchange. Another example of audio file attributes includes a text caption url (denoted by url6). The text caption URL may comprise an optional URL that points to a closed-captioning file in SRT, VTT, or another standard format for closed-captioning data.

In particular embodiments, a video slate composition engine 130 may generate a video slate incorporating the banner asset and synchronize the slate with the duration of the audio media file. The extracted metadata components may be used to generate a unified video advertisement that includes the audio media file, a video slate, and one or more visual or interactive elements derived from the companion banner metadata. A tracking translation engine 140 of the system may translate companion banner interaction tracking mechanisms into corresponding video interaction tracking events. In particular embodiments, the unified video advertisement may be delivered using the IAB VAST standard (e.g., video advertisement in VAST format 150 shown in FIG. 1) or another standard video advertising format. When a new global creative ID (gcrid) is identified, the system may automatically generate a corresponding video media file for that creative, and the video media file may be updated periodically based on newly received or updated advertisement assets or metadata.

In particular embodiments, the system may store the unified video advertisement media file, the audio media file, and one or more of the companion banner metadata in a plurality of network-based non-transitory storage devices that store a collection of video advertisement media files and audio media files. The system may further provide, over a network, a plurality of users with remote access to the unified video advertisement media file, the audio media file, and the stored companion banner metadata. The system may detect an update to the audio media file or one or more of the stored companion banner metadata by one of the users. The system may then convert the update into an updated unified video advertisement media file and store the updated encoded video advertisement media file in the collection of video advertisement media files and audio media files. The system may further automatically transmit the updated unified video advertisement media file to all of the users over the network in real time.

The VAST response is dynamically generated in real time. Such dynamic generation enables customization of the response based on the device type, environment, and impression associated with a request. For example, a mobile video slate may not include a QR code, whereas a CTV or DOOH video slate may include a QR code. Tracking pixels may also vary dynamically on a per-impression basis. Additionally, an appropriate video slate may be selected in real time based on device type, placement, campaign metadata, and/or other request attributes. Accordingly, the system selects or generates the relevant video slate in real time and dynamically generates the VAST response with the tracking pixels appropriate for the corresponding impression.

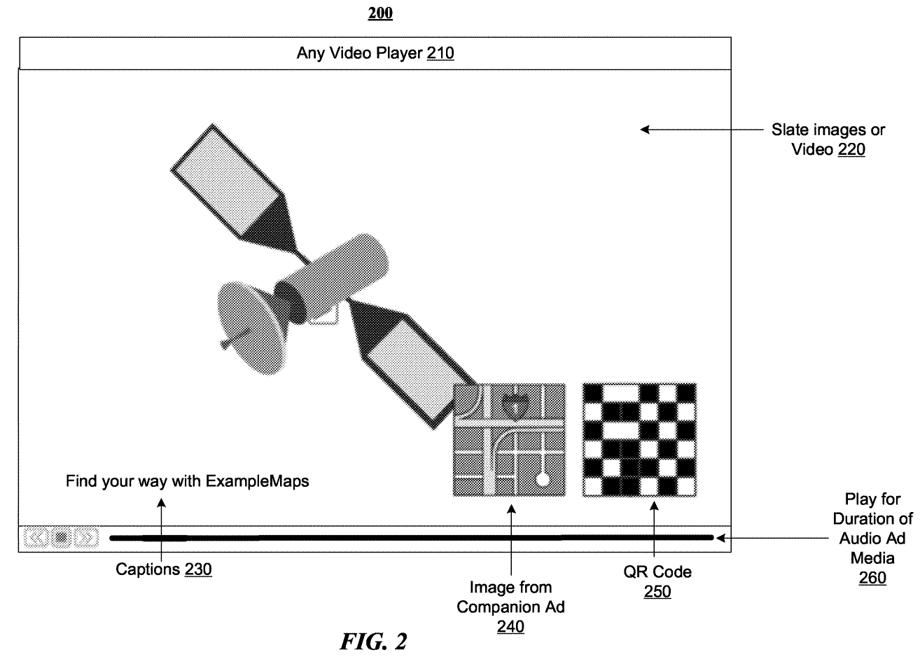

FIG. 2 illustrates an example video slate composition 200. The video slate composition 200 includes a content display region configured to present multimedia content. The media playback application may be any suitable video player 210. Within the content display region, one or more slate images or video 220 may be displayed. The slate images or video 220 may be touch-sensitive on mobile devices. One or more graphical elements may be overlaid on, or presented adjacent to, the slate images or video 220. In the illustrated example, one graphical element includes a text banner including the captions 230 “Find your way with ExampleMaps.” Multiple selectable graphical objects may be also displayed, including an image from a companion advertisement 240 and a QR code 250. The QR code 250 may be from the companion advertisement, click-through URL, and tracking translation engine 140. The video slate composition 200 may further include a scroll control, which plays for duration of the audio advertisement media 260.

In particular embodiments, the video media file may be created by retrieving, converting, and combining the audio media file with a dynamically selected slate file. The system may analyze the audio advertisement response to determine whether the response includes one or more redirects or wrappers. If redirects or wrappers are present, the system may follow the redirect or wrapper chain using standard HTTP GET requests until an inline advertisement or other declaration identifying one or more audio media files is reached. The system may then select and retrieve an audio media file using a standard HTTP GET request.

The slate file may comprise a video file or a static image. The system may adjust the slate file to correspond to the duration of the retrieved audio media file and combine the adjusted slate file with the audio media file to generate the unified video media file. In particular embodiments, the slate file may be selected according to publisher-specific logic, advertiser-specific logic, category-specific logic, or other programmatic selection criteria. Additional metadata-derived visual elements may be incorporated into the unified video media file as described below.

To synchronize the video slate with the duration of the audio media file, the system may obtain available audio file attributes and entity attributes from the audio advertisement response, retrieve additional attributes from one or more network-accessible resources, or infer missing attributes from the audio media file or associated metadata. Such attributes may be acquired before, during, or after generation of the unified video advertisement.

In particular embodiments, the system may retrieve the audio media file and determine an audio duration attribute for the audio media file. The audio duration attribute may be obtained directly from metadata associated with the audio advertisement response, derived from metadata of the retrieved audio media file, or inferred by analyzing playback of the audio media file. After the audio duration attribute is determined, the system may select one or more visual works for incorporation into the video slate based at least in part on the audio duration attribute.

In particular embodiments, the system may select a URL from the click-through URL (url1), the landing page URL (url2), or the advertiser domain (url3) and generate a QR code image based on the selected URL. The selection may be based on one or more suitability criteria, including URL length, redirect behavior, compatibility with QR code generation, or relationship to the advertised product or advertiser. The QR code image may be overlaid on the video slate.

If an advertisement image URL (url4) is present, the system may retrieve the corresponding companion advertisement image using a standard HTTP GET request and incorporate the companion advertisement image into the video slate.

If a text caption URL (url6) is present, the system may retrieve a corresponding caption file using a standard HTTP GET request, convert the caption file into a format suitable for the unified video advertisement, and incorporate caption text into the video slate or encoded video media file. Alternatively or additionally, caption text may be generated by analyzing the audio media file.

In particular embodiments, caption text associated with the audio media file may provide a source of logic for generating the unified video advertisement. The caption text may be received as metadata in the audio advertisement response, manually associated with the audio media file, retrieved from a caption file, or generated by an audio-to-text engine based on analysis of the audio media file. The system may analyze the caption text to identify words, phrases, topics, entities, products, brands, calls to action, geographic references, temporal references, or other semantic signals relevant to the advertised content. Based on the analysis, the system may select or rank one or more URLs, companion images, master visual works, supplemental visual works, overlays, caption-display regions, or other visual or interactive elements for incorporation into the unified video advertisement. For example, the system may use the caption text to identify a landing page or advertiser domain, locate or select images corresponding to products or services described in the audio media file, determine a prospective owner or advertiser associated with the audio media file, or synchronize selected visual works with corresponding time intervals of the audio media file.

The resulting unified video media file may be hosted by an advertisement delivery platform and referenced by a video advertisement response in VAST format or another standard video advertising format. The unified video advertisement may then be used to deliver video advertisement impressions across mobile devices, connected television devices, console devices, digital out-of-home (DOOH) display systems, web-based video players, or other video-capable environments.

In particular embodiments, the system may select visual works from a companion advertisement image, a visual media package associated with the audio advertisement response, an image repository, or another suitable source. Because the system transforms an audio advertisement into a unified video advertisement, the selected visual works may provide visual content corresponding to the audio media file or to one or more entity attributes associated with the advertiser, advertisement creative, advertised product, or audio media file. The visual works may include static images, video clips, graphical elements, three-dimensional renderings, animations, or combinations thereof. In particular embodiments, a single visual work may be displayed for substantially the entire duration of the audio media file. In other embodiments, multiple visual works may be displayed sequentially, concurrently, or with temporal overlap within the video slate.

In particular embodiments, the system may analyze substantive content of the audio media file to select or sequence visual works. For example, the system may generate or obtain a transcript of the audio media file, identify time-coded words or phrases in the transcript, and perform keyword analysis, topic classification, semantic analysis, or another textual analysis process to identify concepts associated with corresponding time intervals of the audio media file. The system may then select, rank, or sequence visual works based on the identified concepts and their associated time intervals. As an example, if a first portion of an audio advertisement describes legal services and a second portion describes patent protection, the system may display a first visual work associated with legal services during the first portion and a second visual work associated with patent protection during the second portion. The selected visual works may be displayed sequentially, concurrently, or with temporal overlap, and may be synchronized with the audio media file based on the identified time intervals.

In addition to visual works, the system may generate or incorporate one or more advertisement element overlays into the video slate. The advertisement element overlays may include a companion advertisement image, a call-to-action element, a relocation banner, a QR code, a barcode, caption text, or another functional or informational visual element. A relocation banner may be overlaid on one or more visual works to provide a visual prompt associated with accessing the advertiser, advertised product, or landing page. In particular embodiments, the system may generate a QR code or other functional image based on the click-through URL (url1), landing page URL (url2), advertiser domain (url3), or another URL associated with the advertisement. The generated functional image may be incorporated into the video slate so that a user may access a corresponding network-accessible resource using a scanning device or other suitable interaction mechanism.

In particular embodiments, the system may generate multiple candidate unified video advertisements from a common audio media file or from a set of audio media files. The generation process may be initialized using one or more parameters, including audio file size, audio duration, audio file type, content category, desired number of candidate advertisements, cost constraints associated with visual works, intended playback device type, geographic information, demographic information, or other metadata available to the system. Based on the initialization parameters, the system may select different combinations, quantities, or temporal arrangements of visual works and advertisement element overlays to generate alternative unified video advertisements. The candidate unified video advertisements may be provided for review, selection, ranking, testing, or delivery. In particular embodiments, the system may operate automatically on stored audio advertisements to generate corresponding unified video advertisements and transmit the generated unified video advertisements, or information identifying the generated unified video advertisements, to one or more advertisement owners, publishers, advertisers, or other authorized entities.

In particular embodiments, the system may store the audio media file used to generate the unified video advertisement media file in a network-based non-transitory storage device. The system may detect an update to the audio media file. Accordingly, the system may generate an updated video slate based on the updated audio media file and encode the updated video slate and the updated audio media file into an updated unified video advertisement media file. The system may further transmit, to the first server, an updated video advertisement response referencing the updated unified video advertisement media file.

The ability to generate multiple candidate unified video advertisements from a common audio media file may provide additional technical and operational advantages. Because visual works, companion advertisement images, call-to-action overlays, QR codes, caption regions, and other advertisement element overlays may be selected or arranged programmatically, the system may generate multiple versions of a video advertisement with different visual compositions, QR code destinations, caption presentations, delivery formats, or tracking configurations. The generated versions may be delivered in parallel across different video-capable environments or evaluated in staged tests. Each generated version may be associated with a corresponding creative identifier or global creative identifier so that impressions, video completion events, video overlay clicks, QR code scans, and other interaction events may be attributed to the particular generated version. Based on measured performance, the system may select, rank, prioritize, suppress, or regenerate one or more candidate unified video advertisements for subsequent delivery.

In particular embodiments, the system may evaluate the performance of the candidate unified video advertisements and use the performance information to inform subsequent selection of visual works or advertisement element overlays for the same advertiser, the same content category, a related campaign, or another advertisement having similar entity attributes. For example, if a particular arrangement of visual works, caption text, call-to-action overlay, or QR code placement is associated with improved completion rates, click events, scan events, or other engagement metrics for advertisements in a particular category, the system may use that information to rank or select similar visual elements when generating later unified video advertisements. The system may store associations between advertisement attributes, selected visual elements, delivery environments, and measured performance in one or more databases, and may use the stored associations to generate, update, or recommend candidate unified video advertisements.

In particular embodiments, the system may make the generated unified video advertisement available to one or more external servers, publishers, advertisement exchanges, demand-side platforms, supply-side platforms, or video players. The system may provide, in a video advertisement response, a reference to the generated video media file and one or more associated video tracking events. The video tracking events may include tracking mechanisms derived from original audio impression trackers, companion impression trackers, companion click trackers, or other tracking URLs extracted from the audio advertisement response. The system may detect event data associated with delivery of the generated unified video advertisement, including impression events, quartile events, completion events, overlay click events, QR code scan events, and downstream conversion or engagement events where available. Because user-level information may be anonymized or limited under applicable advertising standards, the system may aggregate event data or apply attribution logic to determine performance characteristics of individual candidate unified video advertisements, delivery environments, visual works, QR code destinations, or other advertisement attributes.

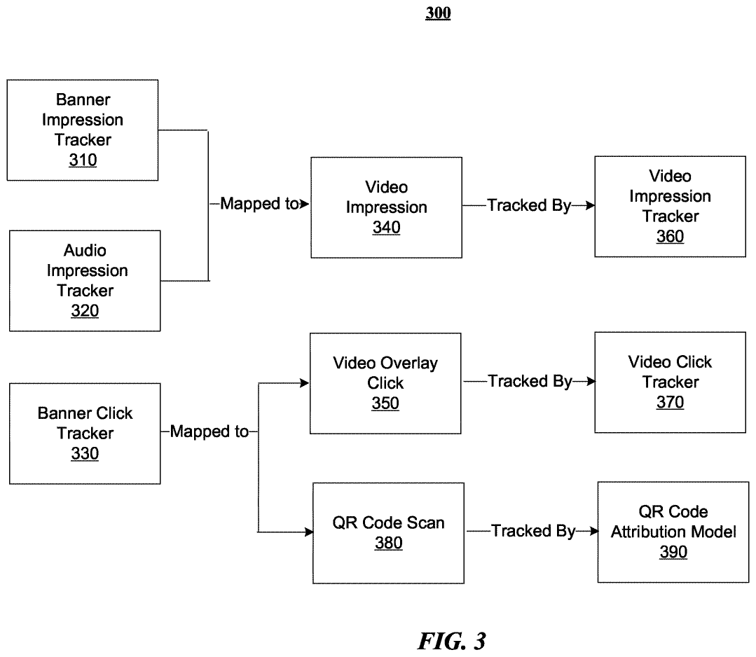

As described with reference to FIG. 1, the system may translate companion banner interaction tracking mechanisms into corresponding video interaction tracking events. FIG. 3 illustrates an example event-driven tracking framework 300 for advertisement interactions across multiple media types. The tracking framework 300 includes a plurality of tracking components associated with different types of advertisement events. In particular embodiments, tracking elements corresponding to non-video interactions may include a banner impression tracker 310, an audio impression tracker 320, and a banner click tracker 330. These elements represent tracking mechanisms invoked upon occurrence of corresponding impression or click events for banner and audio advertisements. In particular embodiments, tracking URLs used by an original audio advertisement including a companion banner may be extracted and incorporated as video trackers within a resulting video advertisement.

Tracking elements may be mapped to video-related events, including a video impression event 340 and a video overlay click event 350. These events may be tracked by corresponding tracking components, such as a video impression tracker 360 and a video click tracker 370, which are configured to record occurrences of video impressions and user interactions with video overlays.

Additionally, the banner click tracker 330 may be mapped to a QR code scan event 380, which is tracked by a corresponding QR code attribution model 390. In particular embodiments, the QR code attribution model 390 is configured to process scan data and attribute user engagement or downstream activity to the QR code interaction. The system employs a proprietary model configured to probabilistically match QR code scans with recently delivered advertisement impressions. Based on the matching, the system triggers click-tracking pixels corresponding to a matched advertiser, campaign, or impression.

FIG. 3 shows the disclosed system can preserve advertiser attribution tracking associated with the companion banner advertisement. In other words, the system can ensure that both video frame clicks and QR code scans both trigger the advertiser's click trackers that were provided for the companion banner.

As described with respect to FIG. 3, QR codes may be uniquely generated as part of video slate composition such that scans are associated with recently delivered advertisement impressions. QR code scans are matched to corresponding impressions using the QR code attribution model 390. In particular embodiments, the QR code attribution model 390 may be a ranked match model in which a set of rules is evaluated in order of priority. Table 1 illustrates example ranked match rules for the QR code attribution model 390. Only impressions occurring within a predetermined time window prior to a scan, including within five minutes, are eligible for matching. QR code scans that do not satisfy at least one of the rules are treated as invalid and do not result in triggering advertiser tracking pixels.

TABLE 1
Ranked match rules.

| | Signal from Ad | Signal from QR | |
|---|---|---|---|
| Priority | Server | Code Scan | Matching Rule |
| 1 | IP Address | IP Address | Same Wi-Fi network |
| | | | or LAN |
| 2 | Subnet (First 3 | Subnet (First 3 | Same ISP and |
| | octets of IP) | octets of IP) | network segment |
| 3 | Geo IP lookup | Geo IP lookup | Same location |

The disclosed system produces a video advertisement media file configured for delivery within video advertising environments, where an original audio advertisement package would otherwise not operate correctly. The system generates video outputs in multiple formats, including mobile, vertical, and connected television formats, and customizes visual elements to correspond to the delivery environment, including incorporation of QR codes for connected television and out-of-home displays. The resulting video advertisement consolidates previously separate advertisement placements into a single video advertisement unit, reducing network requests, client-side rendering complexity, JavaScript execution overhead, and computational resource consumption. The system further enables deployment of audio advertisements within video advertising inventory environments without requiring modification to advertiser tracking infrastructure, wherein audio advertisements are conventionally not compatible with video advertising inventory and companion banners are typically not utilized.

In particular embodiments, an authorized entity associated with the audio advertisement, such as an advertisement owner, publisher, advertiser, campaign manager, or other authorized decision-maker, may review, configure, approve, or modify aspects of the unified video advertisement generated from the audio advertisement response. The authorized entity may access a dashboard configured to present information associated with one or more generated unified video advertisements, including corresponding creative identifiers, global creative identifiers, audio media attributes, selected visual works, companion advertisement images, QR code destinations, caption text, landing page selections, delivery environments, and performance results. The dashboard may further present information identifying video formats or inventory environments in which the unified video advertisement is eligible for delivery, including mobile, web-based video player, connected television, and digital out-of-home environments. Through the dashboard, the authorized entity may select, approve, replace, or reorder visual works; select or confirm a click-through URL, landing page URL, or advertiser domain used to generate a QR code; configure caption or call-to-action overlays; adjust a duration or slate configuration based on the duration of the audio media file; and manage multiple candidate unified video advertisements associated with a common audio media file or creative identifier. In some embodiments, the system may automatically generate or refresh one or more candidate unified video advertisements in response to selection of a control through the dashboard, receipt of updated advertisement metadata, identification of a new global creative identifier, or detection of updated companion assets. Information identifying authorized entities, advertisement owners, publishers, advertisers, or other entities permitted to review or manage generated unified video advertisements may be stored in one or more databases or obtained from one or more network-accessible resources.

The system may further provide performance ratings, rankings, or other aggregate performance data to an authorized decision-maker through the dashboard. The authorized decision-maker may use the performance data to manage advertisement iterations, including by approving a generated version for delivery to one delivery environment, selecting another generated version for a different delivery environment, or replacing a prior version after a selected test period or campaign interval. In some embodiments, the system may automatically apply marketplace or campaign configuration rules to allocate candidate unified video advertisements among different inventory types, audience segments, device classes, geographic regions, or time periods. The allocation may be updated based on measured performance, newly received advertisement metadata, updated companion banner assets, or additional audio advertisements associated with the same advertiser or campaign.

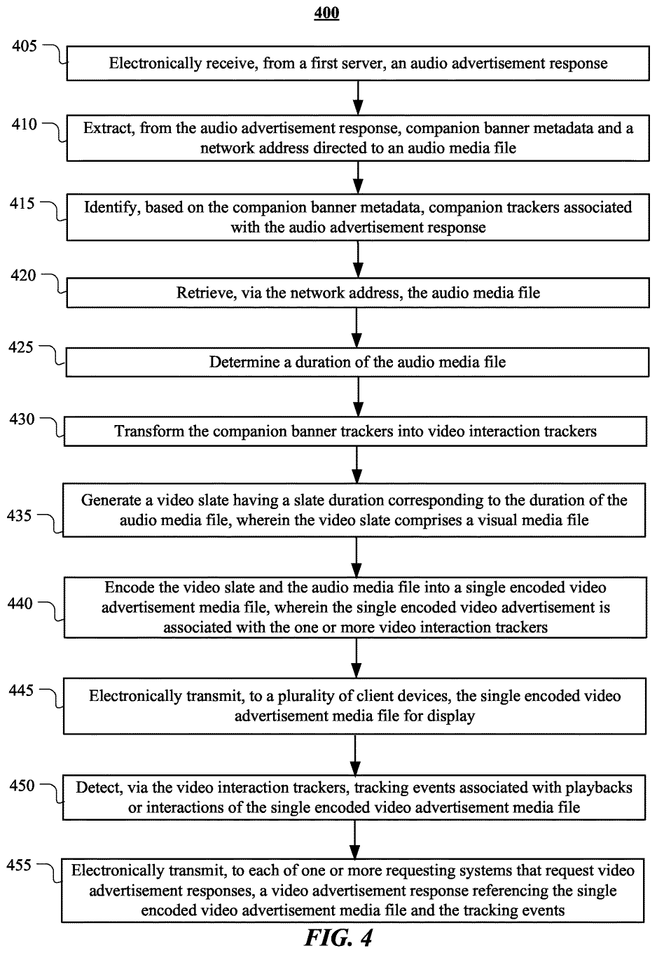

FIG. 4 illustrates an example method 400 for generating unified video advertisements from audio advertisements. At step 405, the system may electronically receive, from a first server, an audio advertisement response. In particular embodiments, the audio advertisement response may be in VAST format. At step 410, the system may extract, from the audio advertisement response, companion banner metadata and a network address directed to an audio media file. At step 415, the system may identify, based on the companion banner metadata, companion trackers associated with the audio advertisement response. In particular embodiments, the one or more companion trackers may comprise one or more of a banner impression tracker, an audio impression tracker, or a banner click tracker. At step 420, the system may retrieve, via the network address, the audio media file. In particular embodiments, retrieving the audio media file may comprise following one or more wrapper redirects in the audio advertisement response until an inline advertisement identifying the audio media file is reached, selecting the audio media file from one or more audio media files identified by the inline advertisement, and retrieving the selected audio media file using a network request. At step 425, the system may determine a duration of the audio media file. The duration may be provided directly within the audio advertisement, inferred from the audio media URL (url5), or provided together with the advertisement by a programmatic advertisement exchange. At step 430, the system may transform the companion banner trackers into video interaction trackers. In particular embodiments, the one or more video interaction trackers may comprise one or more of a video impression tracker, a video click tracker, or a QR code attribution model. At step 435, the system may generate a video slate having a slate duration corresponding to the duration of the audio media file. The video slate comprises a visual media file. At step 440, the system may encode the video slate and the audio media file into a single encoded video advertisement media file. The single encoded video advertisement is associated with the one or more video interaction trackers. At step 445, the system may electronically transmit, to a plurality of client devices, the single encoded video advertisement media file for display. For example, the client devices may include mobile devices, connected television devices, console devices, digital out-of-home (DOOH) display systems, web-based video players, or other video-capable environments. At step 450, the system may detect, via the video interaction trackers, tracking events associated with playbacks or interactions of the single encoded video advertisement media file. At step 455, the system may electronically transmit, to each of one or more requesting systems that request video advertisement responses, a video advertisement response referencing the single encoded video advertisement media file and the tracking events.

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for generating unified video advertisements from audio advertisements including the particular steps of the method of FIG. 4, this disclosure contemplates any suitable method for generating unified video advertisements from audio advertisements including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

### Systems and Methods

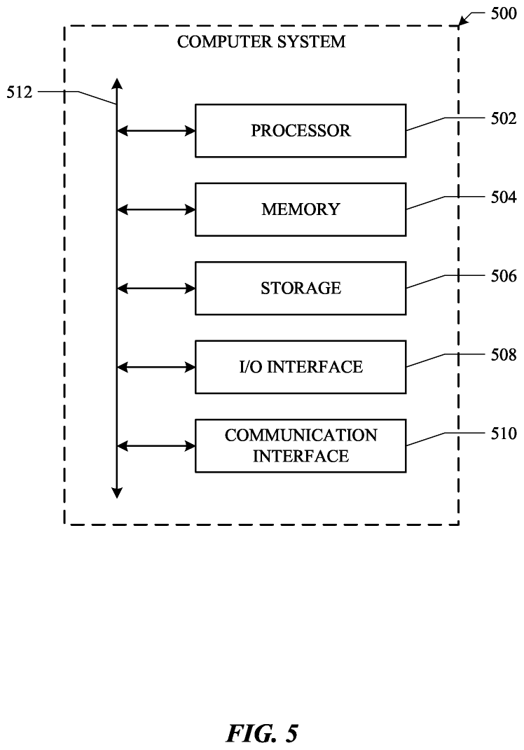

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
electronically receiving, from a first server, an audio advertisement response;
extracting, from the audio advertisement response, companion banner metadata and a network address directed to an audio media file;
identifying, based on the companion banner metadata, one or more companion trackers associated with the audio advertisement response;
retrieving, via the network address, the audio media file;
determining a duration of the audio media file;
transforming the one or more companion banner trackers into one or more video interaction trackers;
generating a video slate having a slate duration corresponding to the duration of the audio media file, wherein the video slate comprises a visual media file;
encoding the video slate and the audio media file into a single encoded video advertisement media file, wherein the single encoded video advertisement is associated with the one or more video interaction trackers;
electronically transmitting, to a plurality of client devices, the single encoded video advertisement media file for display;
detecting, via the one or more video interaction trackers, one or more tracking events associated with playbacks or interactions of the single encoded video advertisement media file; and
electronically transmitting, to each of one or more requesting systems that request video advertisement responses, a video advertisement response referencing the single encoded video advertisement media file and the one or more tracking events.

2. The method of claim 1, further comprising:
storing the single encoded video advertisement media file, the audio media file, and one or more of the companion banner metadata in a plurality of network-based non-transitory storage devices having a collection of video advertisement media files and audio media files stored thereon;
providing, to a plurality of users over a network, remote access to the single encoded video advertisement media file, the audio media file, and the stored companion banner metadata;
detecting an update to the audio media file or one or more of the stored companion banner metadata by one of the users;
converting the update to an updated encoded video advertisement media file;
storing the updated encoded video advertisement media file in the collection of video advertisement media files and audio media files; and
automatically transmitting the updated encoded video advertisement media file to all of the users over the network in real time.

3. The method of claim 1, further comprising:
storing the audio media file in a network-based non-transitory storage device;
detecting an update to the audio media file;
generating an updated video slate based on the update audio media file;
encoding the updated video slate and the updated audio media file into an updated single encoded video advertisement media file; and
electronically transmitting, to the first server, an updated video advertisement response referencing the updated single encoded video advertisement media file.

4. The method of claim 1, wherein retrieving the audio media file comprises:
following one or more wrapper redirects in the audio advertisement response until an inline advertisement identifying the audio media file is reached;
selecting the audio media file from one or more audio media files identified by the inline advertisement; and
retrieving the selected audio media file using a network request.

5. The method of claim 1, wherein the one or more companion trackers comprise one or more of a banner impression tracker, an audio impression tracker, or a banner click tracker.

6. The method of claim 1, wherein the one or more video interaction trackers comprise one or more of a video impression tracker, a video click tracker, or a QR code attribution model.

7. The method of claim 1, wherein generating the video slate comprises incorporating a QR code generated from a click-through URL, a landing page URL, or an advertiser domain associated with the audio advertisement response.

8. The method of claim 7, wherein detecting the tracking events comprises correlating a scan of the QR code with a delivered impression of the single encoded video advertisement media file.

9. The method of claim 8, wherein correlating the scan of the QR code with the delivered impression comprises matching at least one network-location signal associated with the scan to at least one network-location signal associated with the delivered impression within a predetermined time window.

10. The method of claim 1, wherein the one or more companion trackers comprise a banner impression tracker or an audio impression tracker, wherein the one or more video interaction trackers comprise a video impression tracker, and wherein detecting the tracking events comprises:
mapping the banner impression tracker or audio impression tracker to a video impression event tracked by the video impression tracker.

11. The method of claim 1, wherein the one or more companion trackers comprise a banner click tracker, wherein the one or more video interaction trackers comprise a video click tracker or a QR code attribution model, and wherein detecting the tracking events comprises:
mapping the banner click tracker to at least one of a video overlay click event tracked by the video click tracker or a QR code scan event tracked by the QR code attribution model.

12. The method of claim 1, further comprising:
generating a plurality of candidate encoded video advertisement media files from the audio media file;
delivering the plurality of candidate encoded video advertisement media files across the plurality of client devices;
detecting tracking events associated with playbacks or interactions of the plurality of candidate encoded video advertisement media files;
determining performances of the plurality of candidate encoded video advertisement media files based on the tracking events; and
performing one or more actions on the plurality of candidate encoded video advertisement media files based on the performances.

13. The method of claim 12, wherein the one or more actions comprise selecting, ranking, prioritizing, suppressing, or regenerating one or more candidate encoded video advertisement media files of the plurality of candidate encoded video advertisement media files.

14. The method of claim 12, further comprising:
selecting, based on the performances, one or more visual elements from one or more candidate encoded video advertisement media files of the plurality of candidate encoded video advertisement media files, wherein the one or more candidate encoded video advertisement media files are associated with one or more of a particular advertiser, a particular content category, a particular campaign, or a particular entity attribute; and
integrating the selected visual elements into a subsequently generated encoded video advertisement associated with one or more of the particular advertiser, the particular content category, the particular campaign, or the particular entity attribute.

15. The method of claim 1, further comprising:
deriving one or more visual elements from the companion banner metadata, wherein the video slate further comprises the one or more visual elements.

16. One or more computer-readable non-transitory storage media embodying software that is operable when executed to perform operations comprising:
electronically receiving, from a first server, an audio advertisement response;
extracting, from the audio advertisement response, companion banner metadata and a network address directed to an audio media file;
identifying, based on the companion banner metadata, one or more companion trackers associated with the audio advertisement response;
retrieving, via the network address, the audio media file;
determining a duration of the audio media file;
transforming the one or more companion banner trackers into one or more video interaction trackers;
generating a video slate having a slate duration corresponding to the duration of the audio media file, wherein the video slate comprises a visual media file;
encoding the video slate and the audio media file into a single encoded video advertisement media file, wherein the single encoded video advertisement is associated with the one or more video interaction trackers;
electronically transmitting, to a plurality of client devices, the single encoded video advertisement media file for display;
detecting, via the one or more video interaction trackers, one or more tracking events associated with playbacks or interactions of the single encoded video advertisement media file; and
electronically transmitting, to each of one or more requesting systems that request video advertisement responses, a video advertisement response referencing the single encoded video advertisement media file and the one or more tracking events.

17. The computer-readable non-transitory storage media of claim 16, the operations further comprising:
storing the single encoded video advertisement media file, the audio media file, and one or more of the companion banner metadata in a plurality of network-based non-transitory storage devices having a collection of video advertisement media files and audio media files stored thereon;
providing, to a plurality of users over a network, remote access to the single encoded video advertisement media file, the audio media file, and the stored companion banner metadata;
detecting an update to the audio media file or one or more of the stored companion banner metadata by one of the users;
converting the update to an updated encoded video advertisement media file;
storing the updated encoded video advertisement media file in the collection of video advertisement media files and audio media files; and
automatically transmitting the updated encoded video advertisement media file to all of the users over the network in real time.

18. A system comprising: one or more processors; and a non-transitory memory coupled to the processors comprising instructions executable by the processors, the processors operable when executing the instructions to perform operations comprising:
electronically receiving, from a first server, an audio advertisement response;
extracting, from the audio advertisement response, companion banner metadata and a network address directed to an audio media file;
identifying, based on the companion banner metadata, one or more companion trackers associated with the audio advertisement response;
retrieving, via the network address, the audio media file;
determining a duration of the audio media file;
transforming the one or more companion banner trackers into one or more video interaction trackers;
generating a video slate having a slate duration corresponding to the duration of the audio media file, wherein the video slate comprises a visual media file;
encoding the video slate and the audio media file into a single encoded video advertisement media file, wherein the single encoded video advertisement is associated with the one or more video interaction trackers;
electronically transmitting, to a plurality of client devices, the single encoded video advertisement media file for display;
detecting, via the one or more video interaction trackers, one or more tracking events associated with playbacks or interactions of the single encoded video advertisement media file; and
electronically transmitting, to each of one or more requesting systems that request video advertisement responses, a video advertisement response referencing the single encoded video advertisement media file and the one or more tracking events.

19. The system of claim 18, the operations further comprising:
storing the single encoded video advertisement media file, the audio media file, and one or more of the companion banner metadata in a plurality of network-based non-transitory storage devices having a collection of video advertisement media files and audio media files stored thereon;
providing, to a plurality of users over a network, remote access to the single encoded video advertisement media file, the audio media file, and the stored companion banner metadata;
detecting an update to the audio media file or one or more of the stored companion banner metadata by one of the users;
converting the update to an updated encoded video advertisement media file;
storing the updated encoded video advertisement media file in the collection of video advertisement media files and audio media files; and
automatically transmitting the updated encoded video advertisement media file to all of the users over the network in real time.

20. The system of claim 18, the operations further comprising:
storing the audio media file in a network-based non-transitory storage device;
detecting an update to the audio media file;
generating an updated video slate based on the update audio media file;
encoding the updated video slate and the updated audio media file into an updated single encoded video advertisement media file; and
electronically transmitting, to the first server, an updated video advertisement response referencing the updated single encoded video advertisement media file.
